(19) United States
(12) Patent Application Publication
(10) Pub. No.: US 2017/0251114 A1
(43) Pub. Date: Aug. 31, 2017

(54) DISPLAY DEVICE, IMAGE FORMING DEVICE, METHOD OF DISPLAYING KEYPAD SCREEN, AND PROGRAM FOR DISPLAYING KEYPAD SCREEN

(71) Applicant: Konica Minolta, Inc., Tokyo (JP)

(72) Inventors: Shohei ICHIYAMA, Toyokawa-shi (JP); Takeshi HIBINO, Toyokawa-shi (JP); Taketoshi YAMAHATA, Toyokawa-shi (JP); Yukina HISADA, Tokyo (JP)

(73) Assignee: Konica Minolta, Inc., Tokyo (JP)

(21) Appl. No.: 15/440,622

(22) Filed: Feb. 23, 2017

(30) Foreign Application Priority Data
Feb. 25, 2016 (JP) 2016-033955

(51) Int. Cl. H04N 1/00

(52) U.S. Cl. CPC H04N 1/00506; H04N 1/00411; H04N 1/00488; H04N 2201/0094

(57) ABSTRACT

A display device includes: a display unit capable of displaying a setting screen having an input area for an input value and a keypad screen having soft keys on the same screen; a determiner configured to determine an acceptable input value range of the input area displayed on the display unit; and a display controller configured to display only soft keys on the keypad screen, wherein the keypad screen has a fixed area in which the soft key is fixedly displayed and a variable area in which the soft key is variably displayed, the soft keys are classified into a common key and an individual key other than the common key, and the display controller displays the common key in the fixed area of the keypad screen and the individual key in the variable area of the keypad screen out of the soft keys.

The entire disclosure of Japanese Patent Application No. 2016-033955 filed on Feb. 25, 2016 including description, claims, drawings, and abstract are incorporated herein by reference in its entirety.

### BACKGROUND OF THE INVENTION

Field of the Invention

The present invention relates to a display device applied to an operation panel of an image forming device, an image forming device provided with the display device, a method of displaying a keypad screen in a display device or an image forming device, and a program for displaying a keypad screen.

Description of the Related Art

For example, an image forming device called a multi-function peripheral (MFP) having a plurality of functions such as copier, printer, facsimile, and scanner functions is known in the art, in which a setting screen having an input area for input values is displayed in a display unit of an operation panel in order to enable a user to perform various settings such as a print setting, and at the same time, a keypad screen having soft keys is displayed when the user enters input values into the input area in order to allow a user to enter input values into the input area by touching the soft keys on the keypad screen.

However, the input value accepted in the input area is different depending on the input area. For example, only numeric values are accepted in the input area for entering the number of prints. In addition, in the input area for entering a print magnification or a sheet size, a decimal point is accepted in addition to the numeric values. Furthermore, in the input area for entering a destination of the facsimile or F codes, # (hereinafter, referred to as octothorpe) or * (hereinafter, referred to as asterisk) is accepted in addition to the numeric values. Moreover, in the input area for entering a page number, an asterisk is accepted in addition to the numeric values.

In this manner, in the prior art, although the input value accepted in the input area is different depending on each input area, overall soft keys corresponding to overall input values such as numeric values, a decimal point, an octothorpe, and an asterisk are displayed on the keypad screen regardless of which input area is selected as illustrated in the drawings. Therefore, a soft key corresponding to an input value for which no entry is accepted is also displayed.

However, if a soft key corresponding to an input value for which no entry is accepted is displayed when an input value is entered into the input area, a problem may occur as described below.

Note that JP 2014-238704 A discusses an input device having an input controller configured to change an input operation mode of software keys including character input keys displayed on a touch screen into a toggle input mode or a flick input mode and input a character corresponding to an operation for the character input key depending on the changed input operation mode, and a display controller configured to transit input candidate characters allowed to be input subsequently to the operation of the character input key according to the input operation mode and then display the input candidate characters.

That is, while a soft key corresponding to the input value for which no entry is accepted is displayed, a user may mistake it as an acceptable key and erroneously touch it. This increases an operation time accordingly and degrades operability disadvantageously. In some cases, when the soft key is erroneously touched, an error sound may be generated in order to notify that the input value is not accepted. However, in this case, the error sound is annoying disadvantageously.

In this regard, the technique discussed in JP 2014-238704 A described above fails to address this problem.

### SUMMARY OF THE INVENTION

The present invention has been made in view of the aforementioned technical problems, and an object thereof is to provide a display device, an image forming device, a method of displaying a keypad screen, and a program for displaying a keypad screen, capable of preventing degradation of user's operability that is generated when a soft key corresponding to an input value for which no entry is accepted is uselessly displayed on a keypad screen used to enter an input value in an input area displayed on a setting screen, and addressing a problem of an annoying error sound when the error sound is generated.

The above problems are solved by the following means.

(1) To achieve the abovementioned object, according to an aspect, a display device reflecting one aspect of the present invention comprises: a display unit capable of displaying a setting screen having an input area for an input value and a keypad screen having soft keys for entering the input value into the input area on the same screen; a determiner configured to determine an acceptable input value range of the input area displayed on the display unit; and a display controller configured to display only soft keys for entering an input value within the acceptable range determined by the determiner on the keypad screen, wherein the keypad screen has a fixed area in which the soft key is fixedly displayed and a variable area in which the soft key is variably displayed, the soft keys are classified into a common key commonly used in each input area and an individual key other than the common key, and the display controller displays the common key in the fixed area of the keypad screen and the individual key in the variable area of the keypad screen out of the soft keys for entering the input value within the acceptable range determined by the determiner.
(2) The display device of Item. 1, wherein the keypad screen is preferably a soft numeric keypad screen, the common key is preferably a numeric key for entering a numerical value, and the individual key is preferably a key other than the numeric key.
(3) The display device of Item. 1, wherein the setting screen displayed on the display unit preferably has a plurality of input areas having different acceptable input value ranges, and the display controller preferably changes the individual key displayed in the variable area on the keypad screen depending on the input area selected by a user out of the plurality of input areas.
(4) The display device of Item. 1, preferably further comprising a memory unit configured to store a management table for managing the input areas by associating the acceptable input value range of the input area with an input area type and associating the input area type with the input area, wherein the determiner preferably determines an acceptable input value range of a determination target input area on the basis of the management table.
(5) To achieve the abovementioned object, according to an aspect, an image forming device reflecting one aspect of the present invention comprises: the display device of Item. 1; and at least one of a printer unit for printing image data onto a sheet, an image reader unit for reading an image on an original to convert the image into image data, and a facsimile transceiver unit, wherein a setting screen having the input area includes at least one of a setting screen for performing print setting for the printer unit, a setting screen for performing reading setting for the image reader unit, and a setting screen for performing transmit/receive setting for the facsimile transceiver unit.
(6) To achieve the abovementioned object, according to an aspect, a method of displaying a keypad screen in a display device, reflecting one aspect of the present invention comprises the steps of: displaying, on a screen of a display unit, a setting screen having an input area of an input value and a keypad screen having soft keys for entering the input value in the input area; determining an acceptable input value range of the input area displayed on the display unit; and controlling display such that only soft keys for entering an input value within the acceptable range determined in the determining step are displayed on the keypad screen, wherein the keypad screen has a fixed area in which the soft key is fixedly displayed and a variable area in which the soft key is variably displayed, the soft keys are classified into a common key commonly used in each input area and an individual key other than the common key, and in the display control step, out of the soft keys for entering the input value within the acceptable range determined in the determining step, the common key is displayed in the fixed area of the keypad screen, and the individual key is displayed in the variable area of the keypad screen.
(7) The method of displaying a keypad screen in a display device of Item. 6, wherein the keypad screen is preferably a soft numeric keypad screen, the common key is preferably a numeric key for entering a numerical value, and the individual key is preferably a key other than the numeric key.
(8) The method of displaying a keypad screen in a display device of Item. 6, wherein the setting screen displayed on the display unit preferably has a plurality of input areas having different acceptable input value ranges, and in the display control step, the individual key displayed in the variable area on the keypad screen is preferably changed depending on the input area selected by a user out of the plurality of input areas.
(9) The method of displaying a keypad screen in a display device of Item. 6, wherein the display device preferably has a memory unit configured to store a management table for managing the input areas by associating the acceptable input value range of the input area with an input area type and associating the input area type with the input area, and in the determining step, an acceptable input value range of a determination target input area is preferably determined on the basis of the management table.
(10) To achieve the abovementioned object, according to an aspect, a method of displaying a keypad screen in an image forming device, reflecting one aspect of the present invention comprises the steps of: executing the method of Item. 6 using the image forming device provided with the display device; and performing at least one of a step of printing image data onto a sheet, a step of reading an image of an original and converting the image into image data, and a step of transmitting or receiving facsimile data, using the image forming device, wherein a setting screen having the input area includes at least one of a setting screen for performing a print setting in the printing step, a setting screen for performing a reading setting in the reading step, and a setting screen for performing a transmit/receive setting in the facsimile transmitting/receiving step.
(11) To achieve the abovementioned object, according to an aspect, there is provided a non-transitory recording medium storing a computer readable program for displaying a keypad screen, and the program reflecting one aspect of the present invention causes a computer of a display device to execute the method of displaying a keypad screen in a display device of Item. 6.
(12) To achieve the abovementioned object, according to an aspect, there is provided a non-transitory recording medium storing a computer readable program for displaying a keypad screen, and the program reflecting one aspect of the present invention causes a computer of an image forming device to execute the method of displaying a keypad screen in an image forming device of Item. 10.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective view illustrating an appearance of an image forming device provided with a display device according to an embodiment of the invention;

FIG. 2 is a block diagram illustrating an electrical configuration of the image forming device;

FIG. 3 is a diagram illustrating a copy setting screen in a copy mode displayed on a display unit;

FIG. 4 is a diagram illustrating a display cell included in a keypad screen;

FIG. 5 is a diagram illustrating an input area management table in which a relationship between each input area and an acceptable input value is defined;

FIG. 6 is a diagram illustrating a key management table;

FIG. 7 is a diagram illustrating a sheet size setting screen in the copy mode displayed on the display unit;

FIGS. 8A to 8D are diagrams illustrating keypad screens displayed according to an embodiment of the invention;

FIG. 9 is a flowchart illustrating a process of displaying a keypad screen executed on the display device of the image forming device;

FIGS. 10A to 10E are diagrams illustrating keypad screens displayed when one of the input areas is selected and when the other input area is selected on the setting screen where a pair of input areas having different acceptable input value ranges are displayed;

FIG. 11 is a diagram illustrating another example of the input area management table;

FIGS. 12A to 12C are diagrams illustrating a process of displaying the keypad screen when the input areas are managed using the management table of FIG. 11; and

FIG. 13 is a diagram illustrating another display example of the keypad screen.

### DESCRIPTION OF THE PREFERRED EMBODIMENTS

Hereinafter, an embodiment of the present invention will be described with reference to the drawings. However, the scope of the invention is not limited to the illustrated examples.

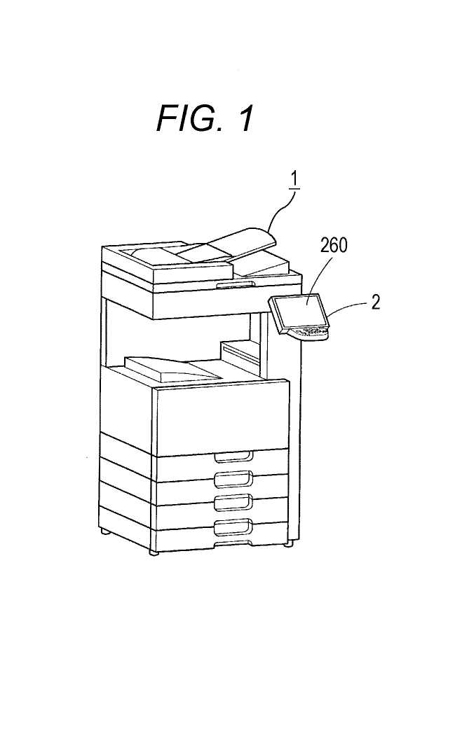

FIG. 1 is a perspective view illustrating an appearance of an image forming device 1 provided with a display device according to an embodiment of the invention. According to an embodiment of the invention, the image forming device 1 is a multi-function peripheral (MFP) as the multi-function digital image forming device described above. In the following description, the image forming device will also be referred to as “MFP.”

The MFP 1 has an operation panel unit 2 as a display device provided in the upper front part. Using the operation panel unit 2, a user enters keys for setting a copy start command or the number of copies or selecting a print mode, and the like. The operation panel unit 2 is provided with a display unit 260 such as a liquid crystal display (LCD) to display various setting screens or messages.

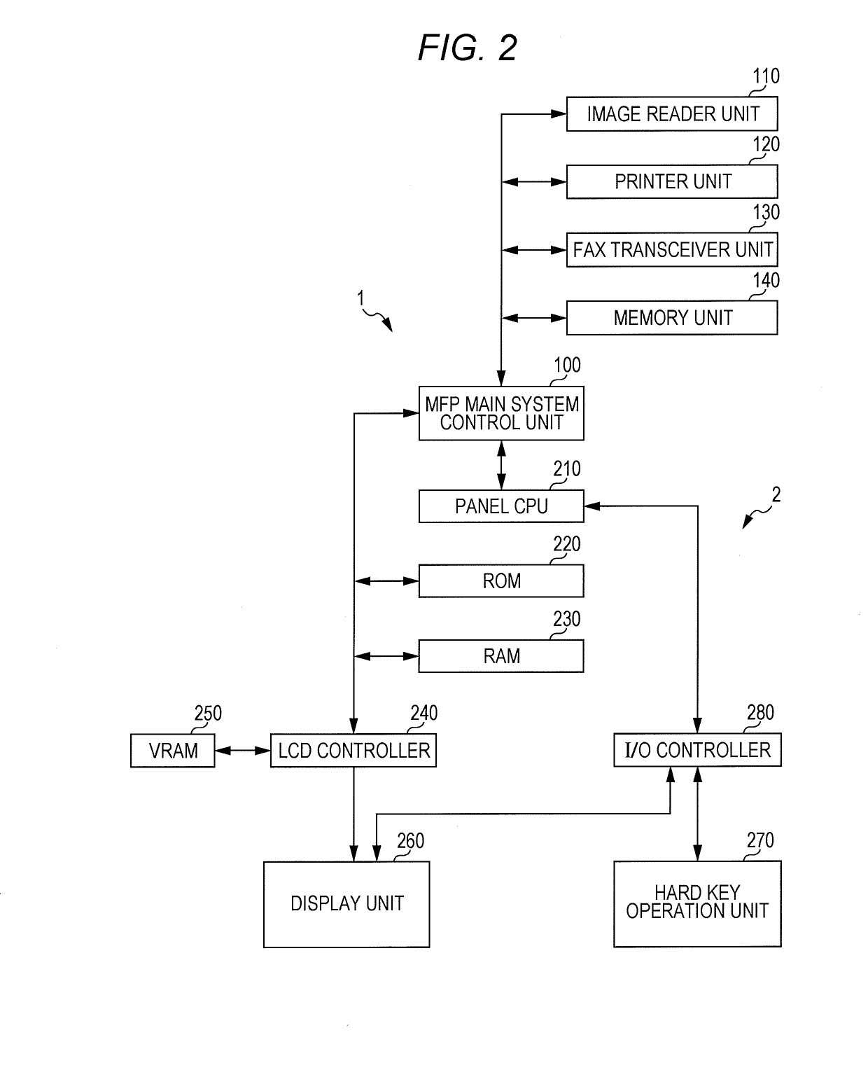

FIG. 2 is a block diagram illustrating an electrical configuration of the MFP 1.

As illustrated in FIG. 2, the MFP 1 includes, in addition to the operation panel unit 2, an MFP main system control unit 100, an image reader unit 110, a printer unit 120, a facsimile (FAX) transceiver unit 130, a memory unit 140, and the like.

The MFP main system control unit 100 totally controls the entire MFP 1 and has a main CPU (not illustrated) to execute various functions such as copy, print, facsimile, and scanner functions in response to a user's operation performed using the operation panel unit 2.

The image reader unit 110 reads the original set thereon to generate image data as electronic data and output them.

The printer unit 120 prints image data output from the image reader unit 110 or print data transmitted from an external device such as a personal computer on a paper sheet fed from a sheet feeding cassette (not illustrated).

The FAX transceiver unit 130 transmits image data to an external facsimile device or receives image data from an external facsimile device via a public switched telephone network.

The memory unit 140 includes, for example, a hard disk drive to store image data output from the image reader unit 110, external data or applications transmitted from the outside, or various other data.

The operation panel unit 2 has a panel CPU 210, a ROM 220, a RAM 230, an LCD controller 240, a VRAM 250, a display unit 260, a hard key operation unit 270, and an input/output controller 280.

The panel CPU 210 performs control for the entire operation panel unit 2 while communicating with the MFP main system control unit 100.

The ROM 220 stores an operation program executed by the panel CPU 210, display image data containing screen data displayed on the display unit 160, and the like. In addition, the RAM 230 provides a work area for allowing the panel CPU 210 to operate on the basis of the operation program stored in the ROM 220.

The LCD controller 240 controls read/write operation of the VRAM 250 and controls display on the display unit 260. Specifically, the image data stored in the ROM 220 is stored in the VRAM 250 in response to a command from the panel CPU 210 and is then read and output to the display unit 260 for display. In addition, when a user performs setting regarding various functions of the MFP 1 or other settings, a setting screen having an input area for the input value or a keypad screen having soft keys for entering input values into the input area is displayed on the display unit 260 in response to a command from the panel CPU 210. This control will be described below in more details.

The display unit 260 is a display device including an LCD touch panel. The display unit 260 displays various screens including a setting screen having the aforementioned input areas, messages, or the like.

The hard key operation unit 270 has a plurality of hard keys such as a start key, a numeric keypad, and a panel reset key, an LED indicating a condition of the MFP 1, a buzzer for notifying a user of a fact that an input/output operation has been made using the hard keys or the display unit 260, and the like.

The input/output controller 280 detects a touch on the display unit 260 directly performed by a user and determines the touch position. In addition, the input/output controller 280 performs input/output control such as a function setting by notifying the panel CPU 210 regarding which function is selected from the functional items displayed on the screen, or the like. Furthermore, the input/output controller 280 controls the hard key operation unit 270 and communicates with the MFP main system control unit 100 through the panel CPU 210 as necessary.

Note that, in the MFP 1, if the start key of the hard key operation unit 270 is pressed, this fact is transmitted to the MFP main system control unit 100 through the input/output controller 280 and the panel CPU 210 to start a series of operations such as a copy operation.

Next, operations of the operation panel unit 2 (MFP 1) performed when the setting screen having the input areas for the input values is displayed on the display unit 260 will be described.

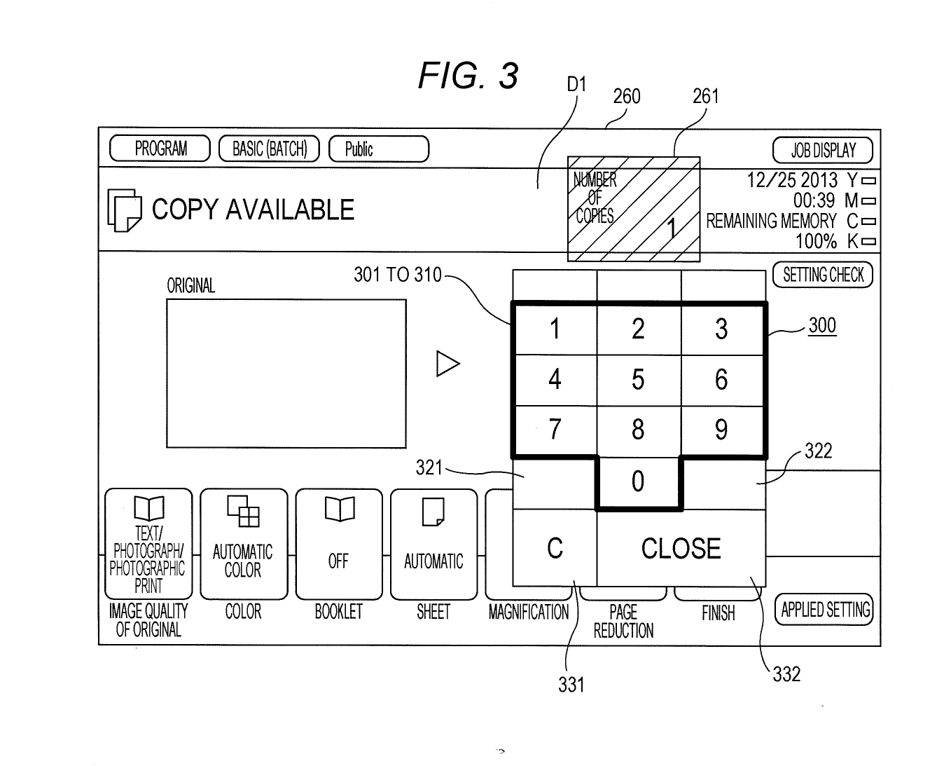

FIG. 3 illustrates a copy setting screen D1 in a copy mode displayed on the display unit 260. This setting screen D1 has an input area 261 for entering the number of prints.

When the setting screen D1 is displayed on the display unit 260, or when a user selects the input area 261 for entering the number of copies, a keypad screen 300 used to enter the number of copies is displayed in a pop-up manner on a screen of the display unit 260 such as the setting screen D1.

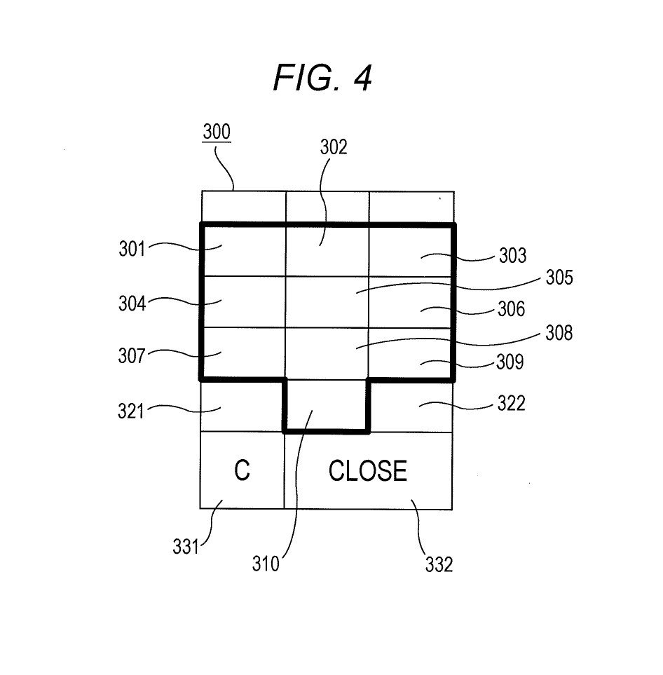

According to an embodiment of the invention, the keypad screen 300 is a soft numeric keypad screen. As illustrated in FIG. 4, the keypad screen 300 has rectangular display cells 301 to 310, 321, and 322 across three rows and four columns on which soft keys for entering input values are displayed.

For each display cell 301 to 310, 321, and 322 of the keypad screen 300, a displayable or non-displayable condition is controlled on a cell-by-cell basis. According to an embodiment of the invention, the display cells are classified into a fixed cell on which the same soft key is fixedly displayed even when the input area is changed, and a variable cell on which the displayed soft key is changed depending on the input area. Specifically, the cells 301 to 310 are fixed cells, and the cells 321 and 322 are variable cells. In addition, the area including the fixed cells 301 surrounded by a bold line in FIG. 4 serves as a fixed area in which common keys are displayed, and the area including the variable cells 321 and 322 serves as a variable area in which individual keys are displayed.

Here, the common key and the individual key will be described. Input values acceptable on the corresponding input area are defined in advance for each input area. For example, only a numeric value is accepted in an input area for entering the number of prints. In addition to the numeric value, a decimal point is accepted in an input area for entering a print magnification or a sheet size. As a result, a numeric value including a decimal point such as “10.5” can be entered. Furthermore, in addition to the numeric value, an octothorpe or an asterisk is accepted in an input area for entering a facsimile destination or an F-code. Moreover, in addition to the numeric value, an asterisk for increasing (+) or decreasing (−) a page number is accepted in an input area for entering a page number.

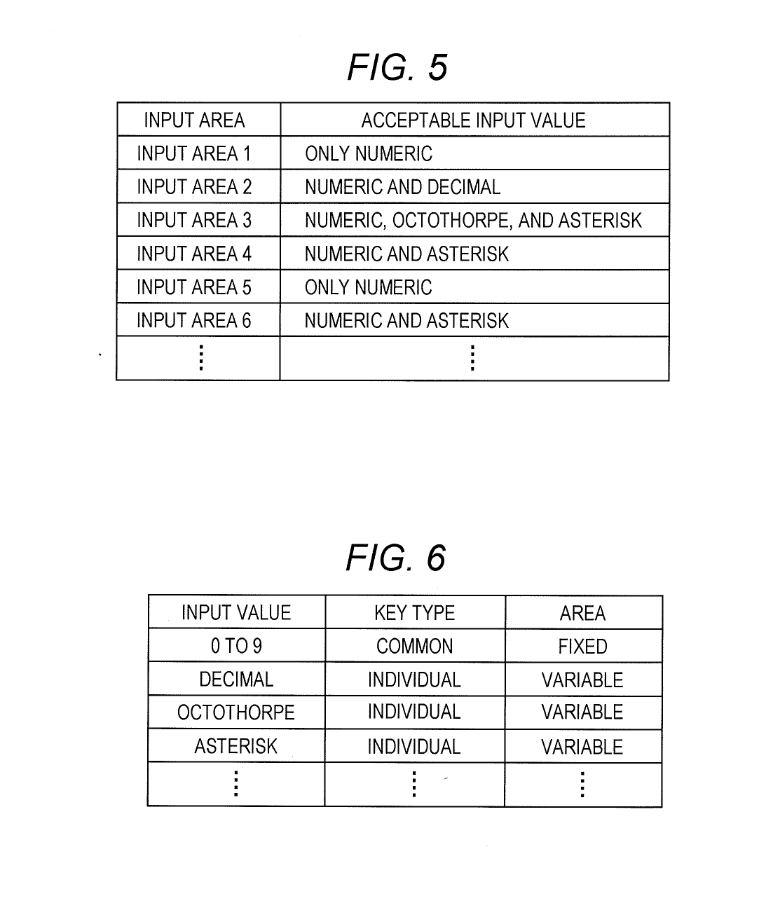

A relationship between each input area and the acceptable input value is illustrated in the input area management table of FIG. 5. This input area management table is stored, for example, in the ROM 220 and the like.

In the example of FIG. 5, the acceptable input value in the input areas 1 and 5 is only a numeric value. The acceptable input value in the input area 2 is a numeric value and a decimal point. The acceptable input value in the input area 3 is a numeric value, an octothorpe, and an asterisk. The acceptable input value in the input areas 4 and 6 is a numeric value and an asterisk.

When a target input area is displayed or selected by a user, an acceptable input value range corresponding to the input area is determined by referring to the input area management table of FIG. 5, and only the input values belong to the determined range are displayed on the keypad screen 300.

The numeric value is an acceptable input value common to each input area. In this regard, according to an embodiment of the invention, as illustrated in the soft key management table of FIG. 6, the numeric keys 1, 2, 3, 4, 5, 6, 7, 8, 9, and 0 for entering a numeric value are set as common keys and are displayed on the fixed cells 301 to 310 that form a fixed area of the keypad screen 300. In addition, which numeric value is displayed on which cell is also set in advance. That is, the common key is used commonly in each input area and is a soft key for entering the acceptable input value. According to an embodiment of the invention, the common keys are defined in the soft key management table of FIG. 6.

Meanwhile, since a decimal point, an octothorpe, and an asterisk other than the numeric values are input values accepted depending on the input area, they are set as individual keys as illustrated in the soft key management table of FIG. 6 and are displayed on the variable cells 321 and 322 that form a variable area of the keypad screen 300. That is, the individual keys are soft keys for entering input values accepted depending on each input area other than those of the common keys. According to an embodiment of the invention, the individual keys are defined in the soft key management table of FIG. 6.

Alternatively, the common and individual keys may not be defined in the soft key management table. Instead, a soft key used to enter a value into overall input areas may be set as the common key, and a soft key otherwise may be set as the individual key. Alternatively, instead of overall input areas, a soft key used to enter a value in the input areas whose number is equal to or larger than a predetermined threshold value may be set as the common key, and a soft key otherwise may be set as the individual key.

In the example of FIG. 3, the input area 261 is used to enter the number of copies. Therefore, the setting may be performed such that only numeric values can be input. The input area 261 corresponds to the input area 1 of the input area management table of FIG. 5.

For this reason, the acceptable input value is determined as “only numeric,” and the keypad screen 300 is displayed such that the numeric keys 1, 2, 3, 4, 5, 6, 7, 8, 9, and 0 are sequentially displayed on the cells 301 to 310 in the fixed area side by side starting from the upper left cell 301, and nothing is displayed on the variable cells 321 and 322 as illustrated in FIG. 3. Note that a soft key 331 displayed in the lower end of the keypad screen 300 is a CANCEL key for canceling the key input, and a soft key 332 is a CLOSE key for closing the display of the keypad screen 300. The CANCEL key 331 and the CLOSE key 332 are displayed on all types of keypad screens 300 at all times.

A user may enter the number of copies using each numeric key displayed on the keypad screen 300.

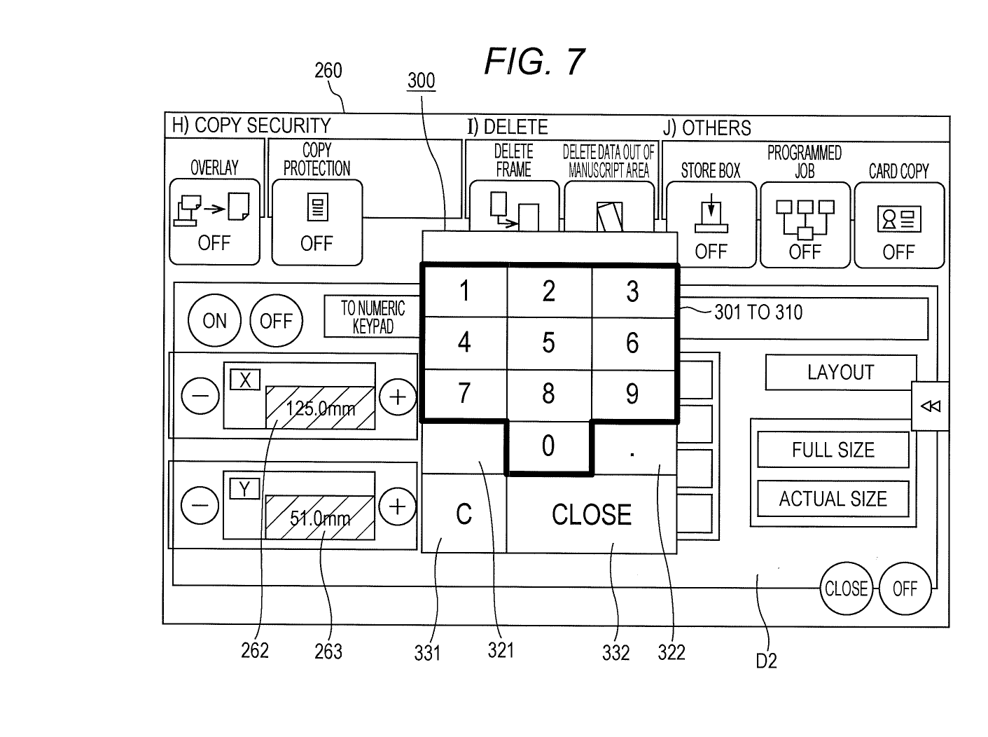

FIG. 7 illustrates a sheet size setting screen D2 in a copy mode displayed on the display unit 260. This setting screen D2 has input areas 262 and 263 for setting horizontal and vertical sizes of a sheet.

When the setting screen D2 is displayed on the display unit 260, or when a user selects the input area 262 or 263 for entering the number of copies, the keypad screen 300 for entering a sheet size is displayed in a pop-up manner on the same screen of the display unit 260 as the setting screen D2.

The sheet size input area may be set such that only numeric values and a decimal point can be input. The sheet size input area corresponds to, for example, the input area 2 of the input area management table of FIG. 5.

For this reason, the acceptable input value is determined as “only numeric” and “decimal point,” and the keypad screen 300 is displayed such that the numeric keys 1, 2, 3, 4, 5, 6, 7, 8, 9, and 0 as common keys are sequentially displayed on the cells 301 to 310 in the fixed area side by side starting from the upper left cell 301, and a decimal point key as the individual key is displayed on the variable cell 322. In addition, nothing is displayed on the variable cell 321 as illustrated in FIG. 7.

A user may enter the sheet size using the numeric keys and the decimal point key displayed on the keypad screen 300.

In this manner, according to an embodiment of the invention, the acceptable input value range of the input areas 261 to 263 is determined, and only the soft keys corresponding to the input value within the determined acceptable range are displayed on the keypad screen 300. Therefore, a useless soft key corresponding to an input value that is not accepted in the input areas 261 to 263 is not displayed. For this reason, a user is prevented from erroneously touching a useless soft key. Therefore, it is possible to prevent an input error and improve operability. Furthermore, since an error sound for notifying that the input value is not accepted is not generated, it is possible to prevent a problem caused by the annoying error sound.

Since the numeric keys as the common keys are displayed in the fixed area, and the individual keys other than the common keys are displayed in the variable area on the keypad screen 300, the numeric keys as the common keys are displayed in the same positions on the keypad screen 300 even when input areas are different, and a different keypad screen 300 is displayed. For this reason, it is possible to remove worry about a possibility of inconvenience that may be generated when the common keys and the individual keys are displayed irregularly without distinction, or when the common keys are displayed in different positions whenever being displayed, so that a user erroneously enters the key. Therefore, it is possible to further improve operability.

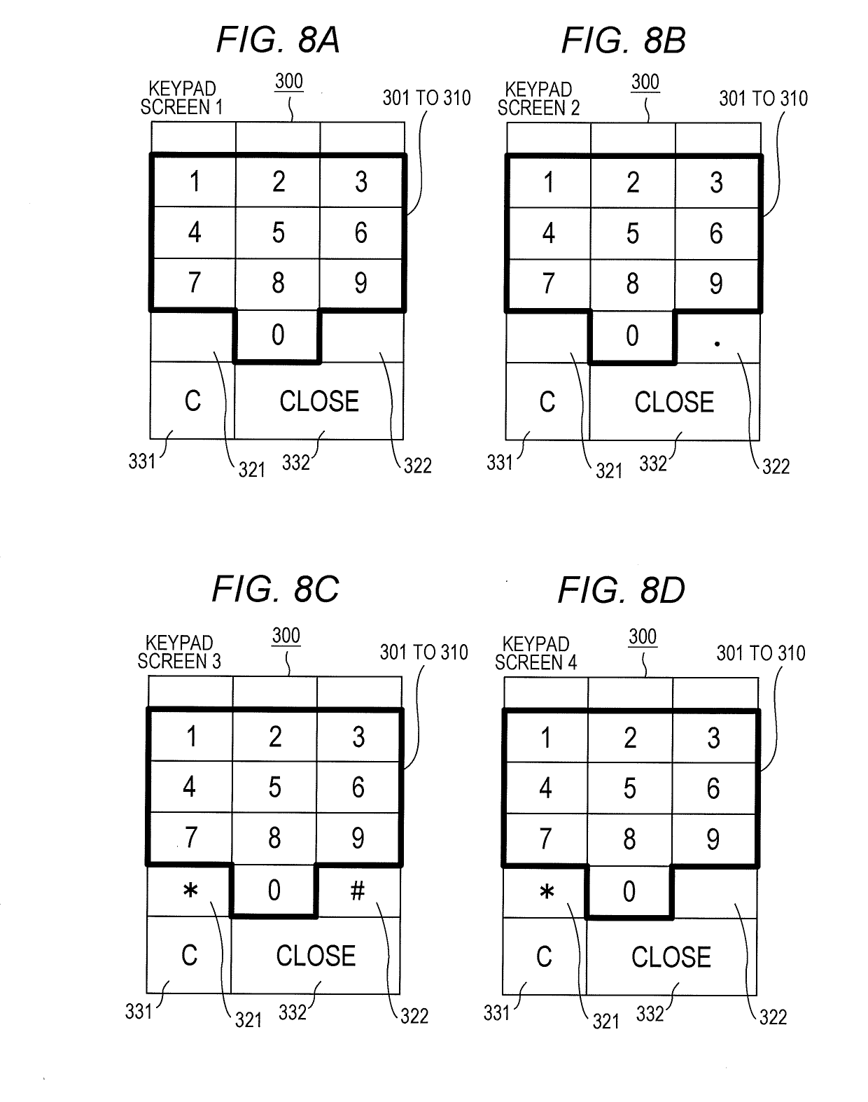

FIGS. 8A to 8D are diagrams collectively illustrating the keypad screen 300 displayed according to an embodiment of the invention. FIG. 8A illustrates the keypad screen 300 displayed in the input area when the acceptable input value range is set as “only numeric.” The keypad screen 300 of FIG. 8A is similar to the keypad screen displayed on the number-of-copy setting screen of FIG. 3 and corresponds to the input areas 1 and 5 of the input area management table of FIG. 5. In the keypad screen 300, the numeric keys 0 to 9 are displayed on the fixed cells 301 to 310, and nothing is displayed on the variable cells 321 and 322.

FIG. 8B is a diagram illustrating the keypad screen 300 displayed in the input area in which the acceptable input value range is set as “numeric” and “decimal point.” The keypad screen 300 of FIG. 8B is similar to the keypad screen displayed on the sheet size setting screen of FIG. 7 and corresponds to the input area 2 of the input area management table of FIG. 5. In this keypad screen 300, the numeric keys 0 to 9 are displayed on the fixed cells 301 to 310, the decimal point key is displayed on the variable cell 322, and nothing is displayed on the variable cell 321.

FIG. 8C is a diagram illustrating the keypad screen 300 displayed in the input area in which the acceptable input value range is set as “numeric,” “octothorpe,” and “asterisk.” The keypad screen 300 of FIG. 8C corresponds to the input area 3 of the input area management table of FIG. 5. In this keypad screen 300, the numeric keys 0 to 9 are displayed on the fixed cells 301 to 310, the asterisk key is displayed on the variable cell 321, and the octothorpe key is displayed on the variable cell 322.

FIG. 8D is a diagram illustrating the keypad screen 300 displayed in the input area in which the acceptable input value range is set as “numeric,” and “asterisk.” The keypad screen 300 of FIG. 8D corresponds to the input areas 4 and 6 of the input area management table of FIG. 5. In this keypad screen 300, the numeric keys 0 to 9 are displayed on the fixed cells 301 to 310, the asterisk key is displayed on the variable cell 321, and nothing is displayed on the variable cell 322.

In any one of the keypad screens 300 displayed in FIGS. 8A to 8D, the numeric keys as the common keys are displayed on the fixed cells 301 to 310 in the fixed area, and all of the decimal point key, the octothorpe key, and the asterisk key as the individual keys are displayed on the variable cell 321 or 322 in the variable area.

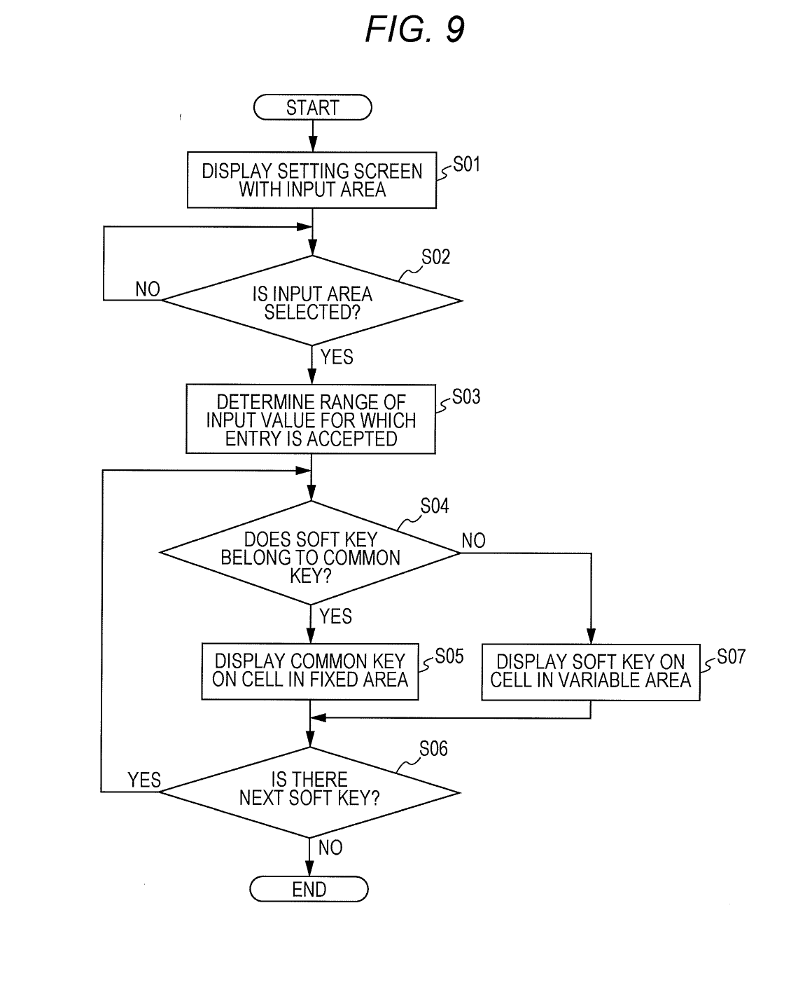

FIG. 9 is a flowchart illustrating a process of displaying the keypad screen executed by the display device 2 of the MFP 1. This process is executed as the panel CPU 210 of the display device 2 (of the MFP 1) is operated on the basis of the operation program stored in the ROM 220 or the like.

In step S01, a setting screen having an input area is displayed on the display unit 260 in response to a user's operation. In step S02, it is determined whether or not the input area is selected. If it is determined that the input area is not selected (NO in step S02), the process waits for the selection.

If the input area is selected (YES in step S02), an acceptable input value range of the selected input area is determined by referring to the input area management table of FIG. 5 in step S03.

Then, in step S04, it is determined whether the corresponding soft key is the common key or the individual key for each of the determined acceptable input values on the basis of the soft key management table of FIG. 6. For example, if the acceptable input value is the numeric key 1, 2, 3, 4, 5, 6, 7, 8, 9, and 0 and the decimal point, it is determined whether each of the numeric keys 1, 2, 3, 4, 5, 6, 7, 8, 9, and 0 and the decimal point key is the common key or the individual key.

If the determination target soft key is the common key (YES in step S04), the soft keys are displayed on the cells in the fixed area in step S05, and the process proceeds to step S06. If the determination target soft key is not the common key (NO in step S04), the soft keys are displayed on the cells in the variable area in step S07, and the process proceeds to step S06.

Note that, since the numeric keys 1, 2, 3, 4, 5, 6, 7, 8, 9, and 0 in the numeric keypad are indispensable, the numeric keys may be directly displayed on the fixed area without determining whether or not the numeric keys are the common keys whenever the keypad screen 300 is displayed. In addition, whether the key is the common key or the individual key may be determined for the keys other than the numeric keys.

In step S06, it is determined whether or not there is a next determination target soft key. If it is determined that there is the next determination target soft key (YES in step S06), the process returns to step S04, and steps S04 to S07 are repeated. If determination on whether or not they are common keys and the display process are completed for all of the soft keys corresponding to the acceptable input values (NO in step S06), the process of displaying the keypad screen is completed.

Through the process described in the flowchart of FIG. 9, only the acceptable input values are displayed on the selected input area of the keypad screen 300. In addition, the common keys of the acceptable input values are displayed on the fixed area, and the individual keys are displayed on the variable area.

Note that, in the process of FIG. 9, determination on whether the key is the common key or the individual key in step S04 is performed on the basis of the soft key management table of FIG. 6. However, the present invention is not limited thereto. Alternatively, it may be determined whether or not each key corresponding to the input value within the acceptable range is used in other input areas on the basis of the input area management table of FIG. 5, and it may be determined that the soft key is the common key if it is used in overall input areas. Otherwise, the soft key may be determined as the individual key. Alternatively, instead of overall input areas, it may be determined the soft key is the common key if it is used in the input areas whose number is equal to or larger than a predetermined threshold value. Otherwise, the soft key may be determined as the individual key.

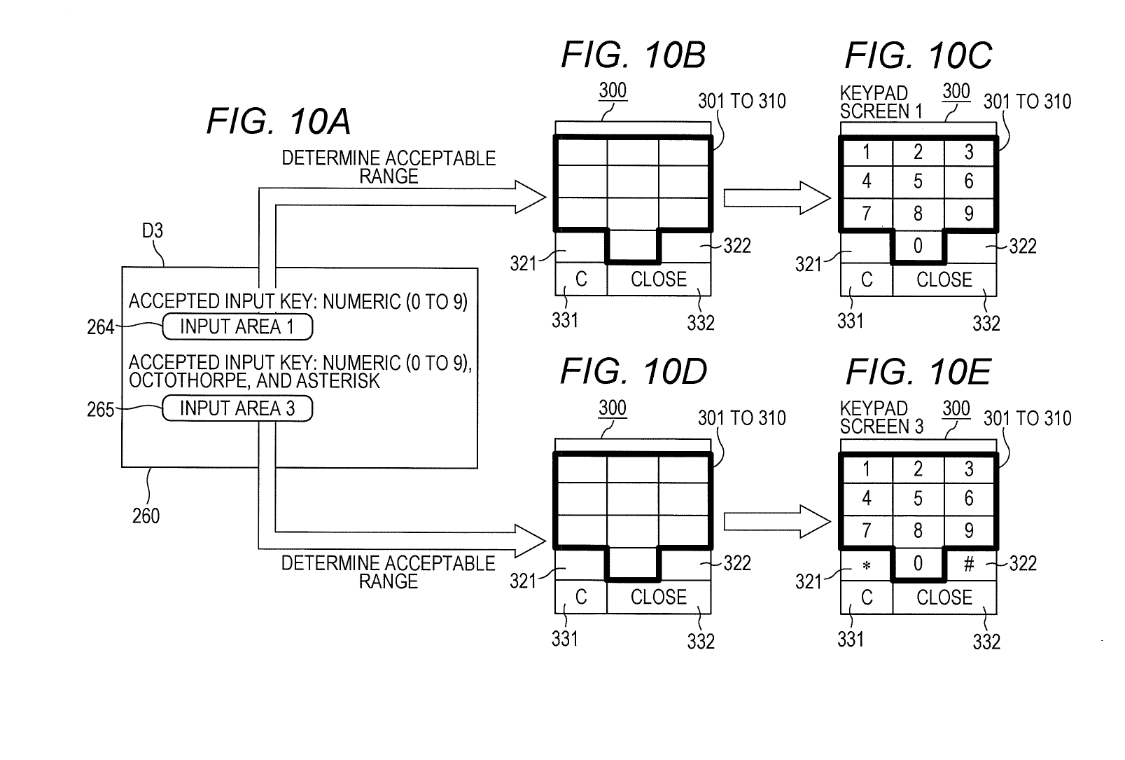

FIGS. 10A to 10E are diagrams illustrating the keypad screens displayed when the input area 264 is selected and when the input area 265 is selected on the setting screen D3 including a plurality of input areas 264 and 265 (in this case, a pair of input areas) having different acceptable input value ranges.

Note that the acceptable input value range of the input area 264 is set to “only numeric” and corresponds to the input area 1 of the input area management table of FIG. 5. The acceptable input value range of the input area 265 is set to “numeric,” “octothorpe,” and “asterisk,” and corresponds to the input area 3 of the input area management table of FIG. 5.

As illustrated in FIG. 10A, when a user touches and selects the input area 264, the acceptable input value range of the input area 264 is determined as “only numeric” by referring to the input area management table of FIG. 5 as indicated by the upper void arrow. In addition, the keypad screen 300 is displayed on the screen D3 in a pop-up manner such that the numeric keys are respectively arranged in the cells 301 to 310 of the of FIG. 10B, and the numeric keys are respectively displayed in the cells 301 to 310 in the fixed area of FIG. 10C.

If a user changes the selection by touching the input area 265 in this state, the acceptable input value range of the input area 265 is determined as “numeric,” “octothorpe,” and “asterisk” by referring to the input area management table of FIG. 5 as indicated by the lower void arrow. In addition, the numeric keys are arranged in the cells 301 to 310, and the octothorpe key and the asterisk key are arranged in the cells 322 and 321, respectively, on the keypad screen 300 of FIG. 10D. Furthermore, as illustrated in FIG. 10E, the keypad screen 300 is displayed on the screen D3 in a pop-up manner such that the numeric keys are respectively displayed in the cells 301 to 310 in the fixed area, the octothorpe key is displayed in the variable cell 322 in the variable area, and the asterisk key is displayed in the variable cell 321 in the variable area. That is, the individual key displayed on the variable area of the keypad screen 300 is changed depending on which of the input areas 264 and 265 is selected.

In this manner, when a plurality of input areas 264 and 265 having different acceptable input value ranges are displayed, the individual key is differently displayed on the variable area of the keypad screen 300 depending on the input area selected by a user. Therefore, a user can enter the input value using the keypad screen on which only the acceptable soft keys are displayed, regardless of a difference of the input area.

Note that, although the setting screen has a pair of input areas in the example of FIGS. 10A to 10E, three or more input areas having different acceptable input value ranges may be displayed on the setting screen. Even in this case, the keypad screen 300 is changed and displayed whenever a user selects the input area.

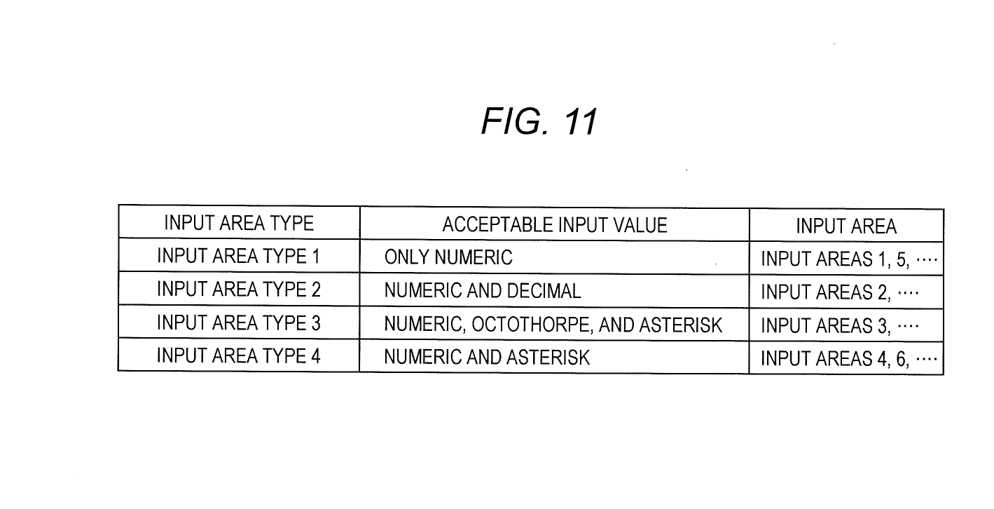

Although the acceptable input value range of the input area is managed for each input area as illustrated in the input area management table of FIG. 5 in the aforementioned embodiments, the acceptable input value range of the input area and the type of the input area may be associated with each other as illustrated in FIG. 11, and furthermore, the type of the input area and the input area may be associated with each other.

That is, as illustrated in the input area management table of FIG. 11, the input area having the acceptable input value range set to “only numeric” is classified into INPUT AREA TYPE 1, and the input area having the acceptable input value range set to “numeric” and “decimal point” is classified into INPUT AREA TYPE 2. In addition, the input area having the acceptable input value set to “numeric,” “octothorpe,” and “asterisk” is classified into INPUT AREA TYPE 3, and the input area having the acceptable input value set to “numeric” and “asterisk” is classified into INPUT AREA TYPE 4.

Using the input area management table of FIG. 11, which input area type is designated to each input area is managed. In the example of FIG. 11, the input areas 1 and 5 belong to INPUT AREA TYPE 1, and the input area 2 belongs to INPUT AREA TYPE 2. In addition, the input area 3 belongs to INPUT AREA TYPE 3, and the input areas 4 and 6 belong to INPUT AREA TYPE 4. Note that the management table of FIG. 11 is stored in the ROM 220 or the like in advance.

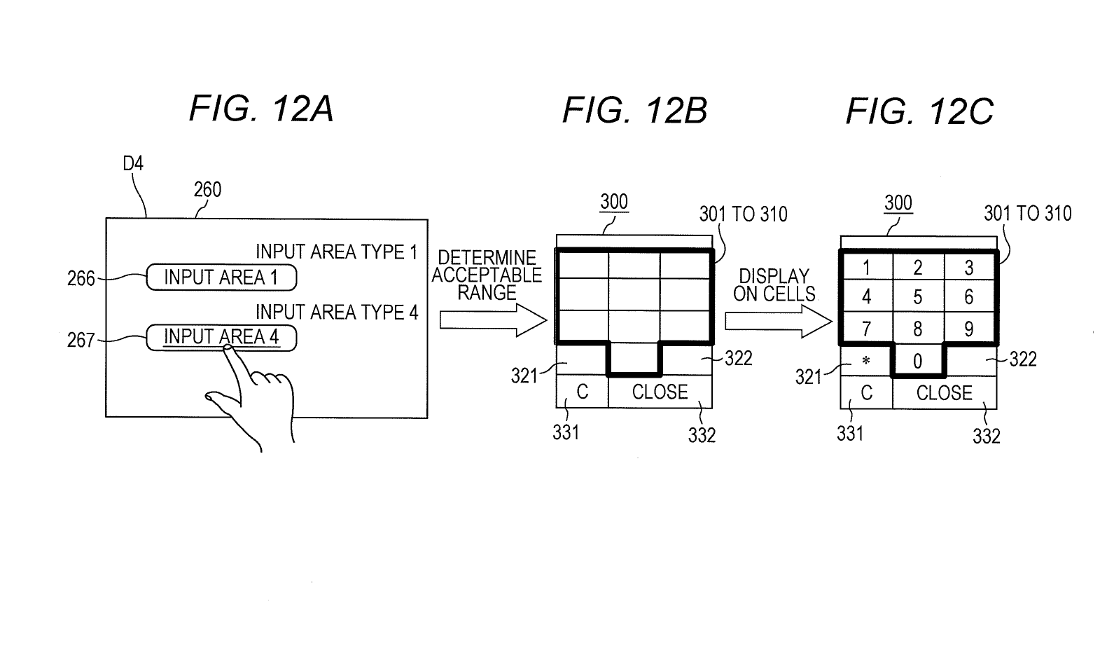

A process of displaying the keypad screen 300 when the input areas are managed in this manner will be described with reference to FIGS. 12A to 12C.

In FIG. 12A, input areas 266 and 267 having different acceptable input value ranges are displayed on the setting screen D4. The acceptable input value range of the input area 266 is set to “only numeric,” and corresponds to the input area 1 of INPUT AREA TYPE 1 in the input area management table of FIG. 11. The acceptable input value range of the input area 267 is set to “numeric” and “asterisk,” and corresponds to the input area 4 of INPUT AREA TYPE 4 in the input area management table of FIG. 11.

As illustrated in FIG. 12A, when a user touches and selects the input area 267, the input area 267 is determined as INPUT AREA TYPE 4 in the input area management table of FIG. 11 and thus has the acceptable input values set to “numeric” and “asterisk.” In addition, the keypad screen 300 of FIG. 10B is displayed on the screen D4 in a pop-up manner such that the soft keys are respectively arranged in the cells 301 to 310 and 321 of the keypad screen 300 of FIG. 10B, the numeric keys are respectively displayed in the cells 301 to 310 of FIG. 10C, and the asterisk key is displayed in the variable cell 321. Similarly, when the input area 266 is selected, the keypad screen 300 is displayed such that the numeric keys are respectively displayed in the cells 301 to 310 in the fixed area.

In this manner, using the management table, the input areas are managed such that the acceptable input value range is associated with the input area type, and the input area type is associated with the input area. Therefore, the acceptable input value range of the target input area is determined on the basis of the management table. As a result, it is possible to remove cumbersomeness that may be generated when the acceptable input value range is managed for each input area.

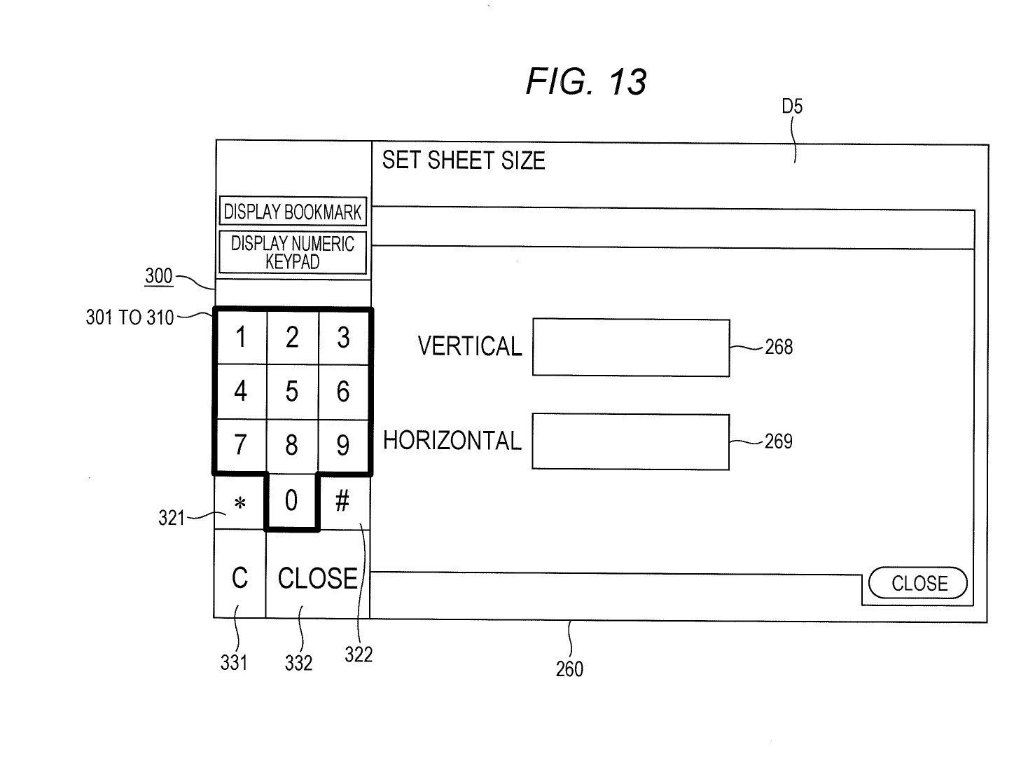

While several embodiments of the invention have been described hereinbefore, it would be appreciated that the present invention is not limited to the aforementioned embodiments. For example, in the aforementioned embodiment, when the setting screen having the input areas is displayed on the display unit 260, or when a user selects the input area, the keypad screen 300 is displayed in a pop-up manner on the screen of the display unit 260. Alternatively, as illustrated in FIG. 13, the keypad screen 300 may be displayed fixedly, for example, in one end of a width direction on the screen of the display unit 260, and the display content on the keypad screen 300 may be changed when the setting screen having the input area is displayed or when the input area is selected.

Although the numeric keys are common keys, and the decimal key, the octothorpe key, and the asterisk key are individual keys in the aforementioned embodiments, the common key and the individual key are not limited thereto. Similarly, the number of cells on the keypad screen is not limited.

Although the keypad screen shows a numeric keypad in the aforementioned embodiments, the keypad screen may also be a soft keyboard screen provided with alphabet keys or numeric keys. In this case, only a soft key for entering the acceptable input value may be displayed in the input area, and the numeric keys and the like may be displayed in the fixed area including the fixed cells of the soft keyboard as common keys. In addition, the individual key may be displayed in the variable cell.

The display device 2 may also be applied to an information processing device such as a smart phone or a tablet terminal, and other devices as well as the MFP 1.

In Items (1) and (6) according to an embodiment of the present invention, the acceptable input value range of the input area displayed on the display unit is determined, and a keypad screen on which only soft keys for entering the input value within the determined acceptable range are displayed is displayed on the same screen of the display unit along with the setting screen having the input area of the input value. Therefore, it is possible to prevent a soft key corresponding to an input value that is not accepted in the displayed input area from being uselessly displayed. As a result, since a user does not touch the useless soft key, it is possible to reduce an input time and improve operability. Furthermore, since an error sound for notifying that the input value is not accepted is not generated, it is possible to remove an annoying error sound problem.

In addition, the keypad screen has a fixed area in which the soft key is fixedly displayed and a variable area in which the soft key is variably displayed, the soft keys are classified into a common key commonly used in each input area and an individual key other than the common key, and out of the soft keys for entering the input value within the determined acceptable range, the common key is displayed in the fixed area of the keypad screen, and the individual key is displayed in the variable area of the keypad screen. Therefore, the keypad screen having the common key in the same position is displayed for entering the input value even when the input area is different. For this reason, it is possible to remove worry about a possibility of inconvenience that may be generated when the common keys and the individual keys are displayed irregularly without distinction, or the common keys are displayed in different positions whenever being displayed, so that a user erroneously enters the key. Therefore, it is possible to further improve operability.

In Items (2) and (7) according to an embodiment of the present invention, the numeric key is displayed in the fixed area of the soft numeric keypad screen, and keys other than the numeric key are displayed in the variable area.

In Items (3) and (8) according to an embodiment of the present invention, the setting screen displayed on the display unit has a plurality of input areas having different acceptable input value ranges, and the individual key displayed in the variable area on the keypad screen is changed depending on the input area selected by a user out of the plurality of input areas. Therefore, a user can enter the input value using the keypad screen on which only acceptable soft keys are displayed without worry about a difference of the input area.

In Items (4) and (9) according to an embodiment of the present invention, the acceptable input value range of the determination target input area is determined on the basis of a management table for managing the input areas by associating the acceptable input value range of the input area with an input area type and associating the input area type with the input area. Therefore, it is possible to remove cumbersomeness that may be generated when the acceptable input value range is managed for each input area.

In Items (5) and (10) according to an embodiment of the present invention, since a user does not touch a useless soft key, it is possible to improve operability and address an annoying error sound problem. In addition, it is possible to provide an image forming device capable of preventing inconvenience that may be generated when the common keys are displayed indifferent positions whenever being displayed, and a user erroneously enters the key.

In Item (11) according to an embodiment of the present invention, the method of displaying the keypad screen in the display device according to Item (6) can be executed in a computer of the display device.

In Item (12) according to an embodiment of the present invention, the method of displaying the keypad screen in the imaging forming device according to Item (10) can be executed in a computer of the image forming device.

Although the present invention has been described and illustrated in detail, it is clearly understood that the same is by way of illustrated and example only and is not to be taken by way of limitation, the scope of the present invention being interpreted by terms of the appended claims.

What is claimed is:

1. A display device comprising:
a display unit capable of displaying a setting screen having an input area for an input value and a keypad screen having soft keys for entering the input value into the input area on the same screen;
a determiner configured to determine an acceptable input value range of the input area displayed on the display unit; and
a display controller configured to display only soft keys for entering an input value within the acceptable range determined by the determiner on the keypad screen,
wherein the keypad screen has a fixed area in which the soft key is fixedly displayed and a variable area in which the soft key is variably displayed,
the soft keys are classified into a common key commonly used in each input area and an individual key other than the common key, and
the display controller displays the common key in the fixed area of the keypad screen and the individual key in the variable area of the keypad screen out of the soft keys for entering the input value within the acceptable range determined by the determiner.

2. The display device according to claim 1, wherein the keypad screen is a soft numeric keypad screen, the common key is a numeric key for entering a numerical value, and the individual key is a key other than the numeric key.

3. The display device according to claim 1, wherein the setting screen displayed on the display unit has a plurality of input areas having different acceptable input value ranges, and
the display controller changes the individual key displayed in the variable area on the keypad screen depending on the input area selected by a user out of the plurality of input areas.

4. The display device according to claim 1, further comprising a memory unit configured to store a management table for managing the input areas by associating the acceptable input value range of the input area with an input area type and associating the input area type with the input area,
wherein the determiner determines an acceptable input value range of a determination target input area on the basis of the management table.

5. An image forming device comprising:
the display device according to claim 1; and
at least one of a printer unit for printing image data onto a sheet, an image reader unit for reading an image on an original to convert the image into image data, and a facsimile transceiver unit,
wherein a setting screen having the input area includes at least one of a setting screen for performing print setting for the printer unit, a setting screen for performing reading setting for the image reader unit, and a setting screen for performing transmit/receive setting for the facsimile transceiver unit.

6. A method of displaying a keypad screen in a display device, comprising the steps of:
displaying, on a screen of a display unit, a setting screen having an input area of an input value and a keypad screen having soft keys for entering the input value in the input area;
determining an acceptable input value range of the input area displayed on the display unit; and
controlling display such that only soft keys for entering an input value within the acceptable range determined in the determining step are displayed on the keypad screen,
wherein the keypad screen has a fixed area in which the soft key is fixedly displayed and a variable area in which the soft key is variably displayed,
the soft keys are classified into a common key commonly used in each input area and an individual key other than the common key, and
in the display control step, out of the soft keys for entering the input value within the acceptable range determined in the determining step, the common key is displayed in the fixed area of the keypad screen, and the individual key is displayed in the variable area of the keypad screen.

7. The method of displaying a keypad screen in a display device according to claim 6, wherein the keypad screen is a soft numeric keypad screen, the common key is a numeric key for entering a numerical value, and the individual key is a key other than the numeric key.

8. The method of displaying a keypad screen in a display device according to claim 6, wherein the setting screen displayed on the display unit has a plurality of input areas having different acceptable input value ranges, and
in the display control step, the individual key displayed in the variable area on the keypad screen is changed depending on the input area selected by a user out of the plurality of input areas.

9. The method of displaying a keypad screen in a display device according to claim 6, wherein the display device has a memory unit configured to store a management table for managing the input areas by associating the acceptable input value range of the input area with an input area type and associating the input area type with the input area, and
in the determining step, an acceptable input value range of a determination target input area is determined on the basis of the management table.

10. A method of displaying a keypad screen in an image forming device, comprising the steps of:
executing the method according to claim 6 using the image forming device provided with the display device; and
performing at least one of a step of printing image data onto a sheet, a step of reading an image of an original and converting the image into image data, and a step of transmitting or receiving facsimile data, using the image forming device,
wherein a setting screen having the input area includes at least one of a setting screen for performing a print setting in the printing step, a setting screen for performing a reading setting in the reading step, and a setting screen for performing a transmit/receive setting in the facsimile transmitting/receiving step.

11. A non-transitory recording medium storing a computer readable program for displaying a keypad screen, the program causing a computer of a display device to execute the method of displaying a keypad screen in the display device according to claim 6.

12. A non-transitory recording medium storing a computer readable program for displaying a keypad screen, the program causing a computer of an image forming device to execute the method of displaying a keypad screen in the image forming device according to claim 10.
